(19) United States
(12) Patent Application Publication
(10) Pub. No.: US 2023/0335946 A1
(43) Pub. Date: Oct. 19, 2023

(54) CONNECTOR GUIDE DEVICE

(71) Applicant: Mantis Yesway Co., Ltd., New Taipei City (TW)

(72) Inventor: Da-Yu Liu, New Taipei City (TW)

(21) Appl. No.: 17/721,377

(22) Filed: Apr. 15, 2022

(51) Int. Cl. H01R 13/629

(52) U.S. Cl. CPC H01R 13/629

(57) ABSTRACT

A connector guide device includes an insulation case, a securing case and a fastening member. The insulation case has a front end and a rear end. The front end of the insulation case has a size different from a size of the rear end of the insulation case. The front end of the insulation case can enter an internal space of the securing case. An upper raised block and a lower raised block of the insulation case are respectively plugged into an upper raised block retaining socket and a lower raised block retaining socket of the securing case to assemble the insulation case and the securing case with each other to form a connector. A circuit board passes through and protrudes from the connector. In connection process, the connector guide device provides guiding effect for the circuit board.

### BACKGROUND OF THE INVENTION

### 1. Field of the Invention

The present invention relates generally to a connector, and more particularly to a connector guide device.

### 2. Description of the Related Art

It is known that an electronic connector (or so-called circuit connector or electrical connector) serves to mate and connect conductive wire with a component to be connected. The connector can quickly close or open a circuit. The connector is generally used to transmit power and signals. The often seen connectors include universal serial bus (USB), IEEE 1394, small computer system interface (SCSI), serial attached SCSI (SAS), etc. These connectors are widely applied to various electrical connection circuits.

When mating and assembling the connector, the plug (male connector) is plugged into the socket (female connector). By means of the connection between the plug and the socket, two ends of the circuit can be quickly electrically connected to close the circuit. Reversely, when the plug is unplugged from the socket, the circuit is quickly opened. However, in case of poor guide between the plug and the socket, in the plugging process, the circuit board of the connector is apt to have a short-circuit with other metal to cause burnout of the device. Also, in case the plug is plugged into the socket in a non-specific path, the plug or the socket may be bent and damaged to cause structural damage of the device and bad affection.

### SUMMARY OF THE INVENTION

It is therefore a primary object of the present invention to provide a connector guide device, which can prevent the circuit board from being plugged into the socket in a non-specific path to cause structural damage of a device.

It is a further object of the present invention to provide the above connector guide device, which can enhance the connection tightness between the outer case and the connector so as to prevent the outer case from being connected with the connector by insufficient tightness to cause sporadic electrical connection.

To achieve the above and other objects, the connector guide device of the present invention includes an insulation case, a securing case and a fastening member. The fastening member is disposed in a fastening member receiving cavity of the securing case. The fastening member has a plane plate. At least one raised body is disposed on the plane plate for connecting with an outer case. The front end of the insulation case has a size different from a size of the rear end of the insulation case. The front end of the insulation case can enter an internal space of the securing case. An upper raised block and a lower raised block of the insulation case are respectively plugged into an upper raised block retaining socket and a lower raised block retaining socket of the securing case to assemble the insulation case and the securing case with each other to form a connector. A circuit board passes through and protrudes from the connector. In connection process, the connector guide device provides guiding effect for the circuit board.

In the above connector guide device, at least one guide member is further disposed at the rear end of the insulation case and at least one restriction member is further disposed on the top section of the securing case. By means of the restriction member disposed on the top section of the securing case, in the assembling process of the guide member of the insulation case and the securing case, the guiding effect is enhanced.

In the above connector guide device, stop sections are further respectively disposed on the two lateral sections of the securing case. The outer case is formed with recesses corresponding to the stop sections. In the assembling process of the securing case and the outer case, the outer case can be directly pushed into the securing case until the recesses are stopped by the stop sections from further entering the securing case. Accordingly, the outer case is prevented from over-inserted or under-inserted into the securing case to cause poor contact between the outer case and the circuit board.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective assembled view of the present invention;

FIG. 2 is a perspective exploded view of the present invention;

FIG. 3 is a perspective view of the insulation case of the present invention, seen by a first angle;

FIG. 4 is a perspective view of the insulation case of the present invention, seen by a second angle;

FIG. 5 is a perspective view of the securing case of the present invention, seen by a first angle;

FIG. 6 is a perspective view of the securing case of the present invention, seen by a second angle;

FIG. 7 is a perspective view of the securing case of the present invention, seen by a third angle;

FIG. 8 is a perspective view of the fastening member of the present invention, seen by a first angle;

FIG. 9 is a perspective view of the fastening member of the present invention, seen by a second angle;

FIG. 10 is a perspective view of the present invention, showing that the connector of the present invention is to be assembled with the outer case;

FIG. 11 is a perspective view of the outer case of the present invention, seen by a first angle;

FIG. 12 is a perspective view of the fastening member of the present invention, seen by a second angle;

FIG. 13 is a perspective view of the connector of the present invention, seen by a first angle and showing that the insulation case and the securing case are connected with each other to form the connector;

FIG. 14 is a perspective view of the connector of the present invention, seen by a second angle and showing that the insulation case and the securing case are connected with each other to form the connector;

FIG. 15 is a plane view of another embodiment of the present invention; and

FIG. 16 is a perspective view of still another embodiment of the present invention.

### DETAILED DESCRIPTION OF THE PREFERRED EMBODIMENTS

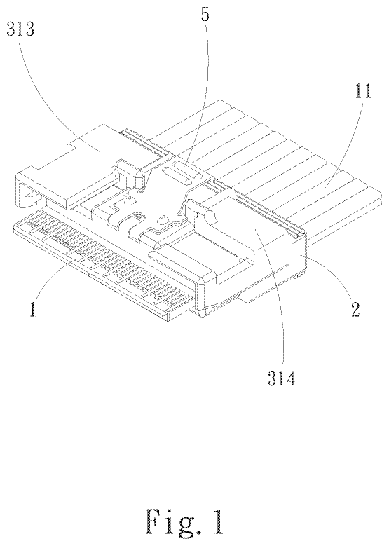

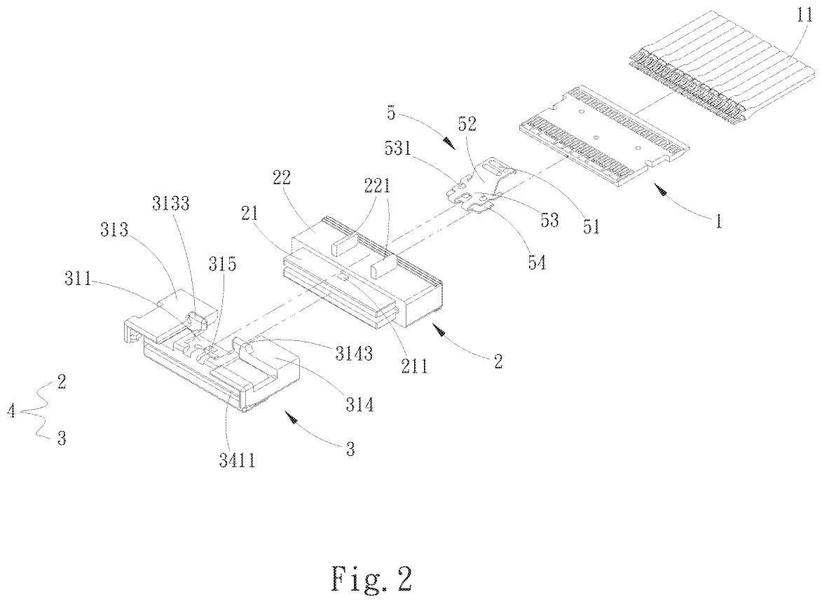

Please refer to FIGS. 1 and 2. FIG. 1 is a perspective assembled view of the present invention. FIG. 2 is a perspective exploded view of the present invention. The present invention mainly includes an insulation case 2, a securing case 3 and a fastening member 5.

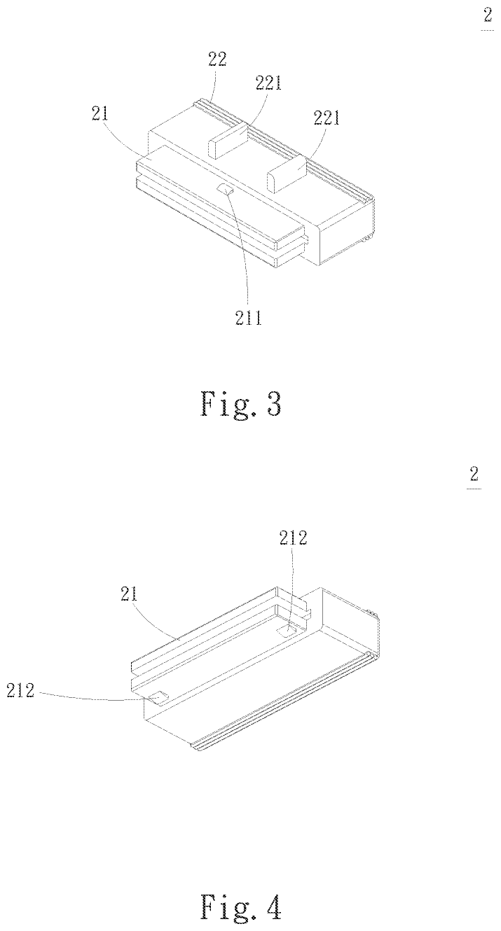

Please refer to FIGS. 3 and 4, which show the insulation case of the present invention by different angles. The insulation case 2 has a front end 21 and a rear end 22. The insulation case 2 is for a circuit board 1 to pass through. A front side of the circuit board 1 outward protrudes from the front end 21 of the insulation case 2. The front end 21 of the insulation case 2 has a size different from a size of the rear end 22 of the insulation case 2. An upper raised block 211 and at least one lower raised block 212 are disposed at the front end 21 of the insulation case 2. The circuit board 1 is connected with multiple wire bodies 11. The wire bodies 11 are received in the insulation case 2 so as to avoid electric shock due to mis-touch of a user.

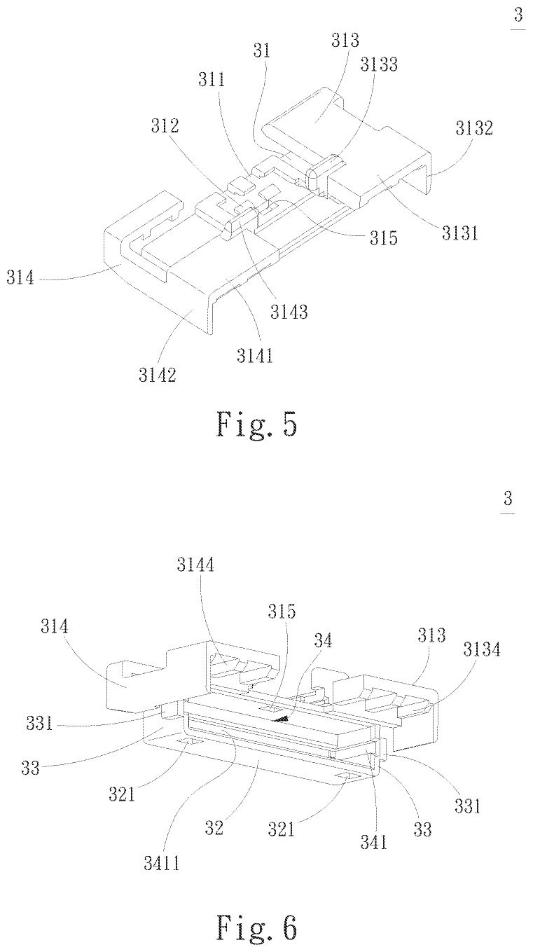

Please refer to FIGS. 5, 6 and 7, which show the securing case of the present invention by different angles. The securing case 3 has a top section 31, a bottom section 32 and two lateral sections 33, which together define an internal space 34. The securing case 3 is disposed at the front end 21 of the insulation case 2. A rail 341 is disposed in the internal space 34 of the securing case 3. The rail 341 extends through the securing case 3 to form an elongated slot 3411. The front side of the circuit board 1 passes through the elongated slot 3411 to outward protrude from the securing case 3. On the top section 31 of the securing case 3 are disposed a fastening member receiving cavity 311, at least one fastening member retaining section 312, a first extension section 313, a second extension section 314 and an upper raised block retaining socket 315. The first extension section 313 outward extends from one side of the top section 31 of the securing case 3. The second extension section 314 outward extends from the other side of the top section 31 of the securing case 3. Each of the first and second extension sections 313, 314 has a horizontal portion 3131, 3141 and a vertical portion 3132, 3142. The horizontal portions 3131, 3141 of the first and second extension sections 313, 314 are in parallel to the top section 31 of the securing case 3. The vertical portions 3132, 3142 of the first and second extension sections 313, 314 are in parallel to the lateral sections 33 of the securing case 3. At least one lower raised block retaining socket 321 is disposed on the bottom section 32. The size of the front end 21 of the insulation case 2 is different from the size of the rear end 22 of the insulation case 2 so that the front end 21 of the insulation case 2 can be inserted in the internal space 34 of the securing case 3. The upper raised block retaining socket 315 and the lower raised block retaining socket 321 of the securing case 3 correspond to the upper raised block 211 and the lower raised block 212 disposed on the front end 21 of the insulation case 2, whereby the upper raised block 211 and the lower raised block 212 of the insulation case 2 can be plugged into the upper raised block retaining socket 315 and the lower raised block retaining socket 321 to assemble the insulation case 2 and the securing case 3 with each other to form a connector 4. The upper raised block 211 and the lower raised block 212 are engaged with the upper raised block retaining socket 315 and the lower raised block retaining socket 321 so as to enhance the connection stability.

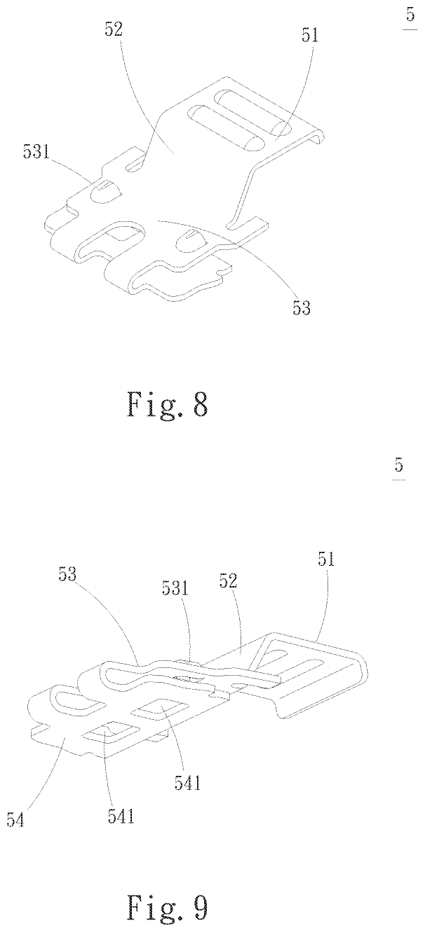

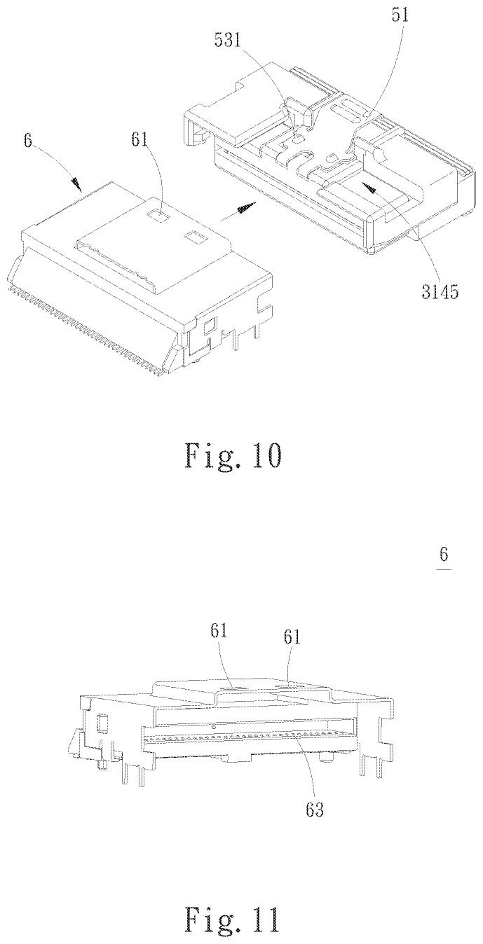

Please refer to FIGS. 8 and 9, which show the fastening member of the present invention by different angles. The fastening member 5 is disposed in the fastening member receiving cavity 311 of the securing case 3. The fastening member 5 has a press section 51, a slope 52 and a plane plate 53. One side of the plane plate 53 is connected with the slope 52. A base plate 54 windingly extends from the other side of the slope 52. The base plate 54 is formed with at least one perforation 541 corresponding to the fastening member retaining section 312 of the securing case 3. One side of the press section 51 is connected with the slope 52, while the other side of the press section 51 is positioned above the top section 31 of the securing case 3. At least one raised body 531 is disposed on a surface of the plane plate 53 for connecting with an outer case 6. Please refer to FIG. 10. The outer case 6 has at least one retaining hole 61 for retaining the raised body 531 of the fastening member 5. When assembled, the connector 4 is connected with the outer case 6 via the fastening member 5. The raised body 531 of the fastening member 5 is inlaid in the retaining hole 61 of the outer case 6, whereby the outer case 6 is securely connected with the connector 4. Accordingly, the connection tightness between the outer case 6 and the connector 4 is enhanced. When disassembling the connector 4 from the outer case 6, the press section 51 of the fastening member 5 is pressed down to make the raised body 531 of the fastening member 5 downward separated from the retaining hole 61 of the outer case 6. Accordingly, the outer case 6 can be easily and quickly detached from the connector 4.

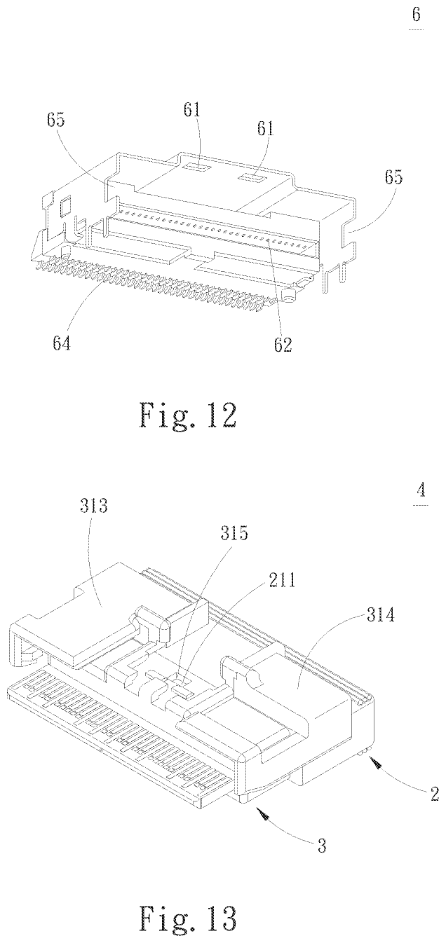

Please refer to FIGS. 11 and 12, which show the outer case of the present invention by different angles. The outer case 6 has at least one retaining hole 61 for retaining the raised body 531 of the fastening member 5, multiple upper mating terminals 62, multiple lower mating terminals 63 and multiple electrical connection extension sections 64. The raised body 531 of the fastening member 5 is inlaid in the retaining hole 61 of the outer case 6 and the front side of the circuit board 1 is inserted into the outer case 6. The front side of the circuit board 1 is correspondingly electrically connected with the upper and lower mating terminals 62, 63 and the upper and lower mating terminals 62, 63 are electrically connected with the electrical connection extension sections 64. Accordingly, the outer case 6 can extensively transmit the signals of the wire bodies 11 of the circuit board 1.

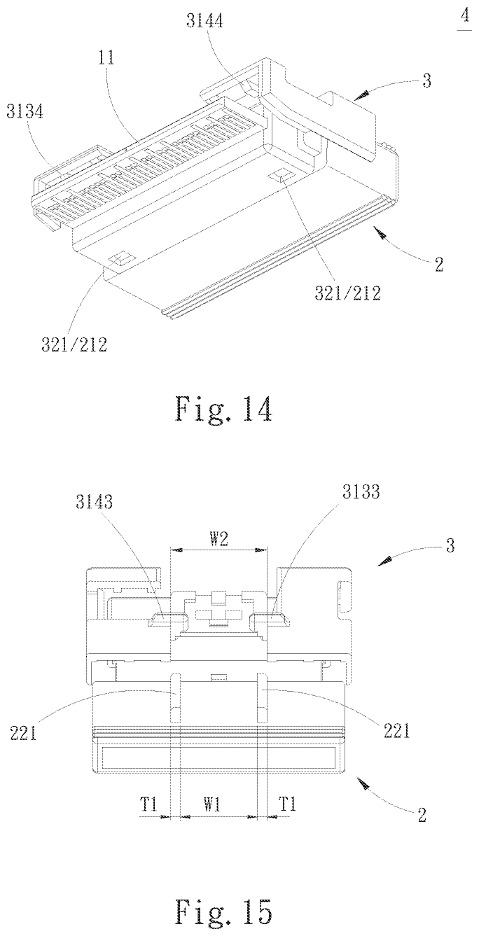

Please refer to FIGS. 13 and 14. FIG. 13 is a perspective view of the connector of the present invention, seen by a first angle and showing that the insulation case and the securing case are connected with each other to form the connector. FIG. 14 is a perspective view of the connector of the present invention, seen by a second angle and showing that the insulation case and the securing case are connected with each other to form the connector. In practice, the size of the front end 21 of the insulation case 2 is different from the size of the rear end 22 of the insulation case 2. In addition, the upper raised block 211 and the lower raised block 212 of the front end 21 of the insulation case 2 correspond to the upper raised block retaining socket 315 and the lower raised block retaining socket 321 of the securing case 3, whereby the front end 21 of the insulation case 2 can be inserted into the internal space 34 of the securing case 3 and the upper raised block 211 and the lower raised block 212 are plugged into the upper raised block retaining socket 315 and the lower raised block retaining socket 321. The rear end 22 of the insulation case 2 is larger than the front end 21 of the insulation case 2 so that after the front end 21 is inserted into the internal space 34 of the securing case 3, the rear end 22 is prevented from entering the internal space 34 of the securing case 3. The front side of the circuit board 1 sequentially passes through and protrudes from the insulation case 2 and the securing case 3. In addition, the rail 341 in the internal space 34 of the securing case forms an elongated slot 3411 so that the circuit board 1 can enter the outer case 6 through the rail 341 of the securing case 3. The front side of the circuit board 1 is electrically connected with the upper and lower mating terminals 62, 63 in the outer case 6. Accordingly, in the connecting process, the present invention can provide a guiding effect for the circuit board 1.

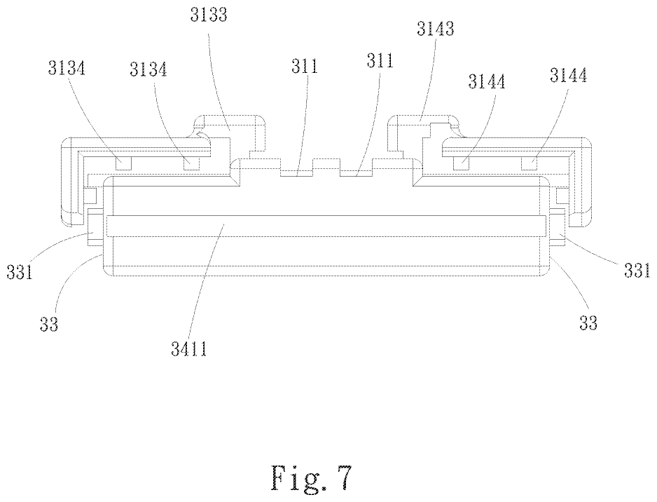

Please refer to FIGS. 6 and 7, which show the securing case of the present invention by different angles. A second embodiment of the present invention is different from the first embodiment in that multiple rib sections 3134, 3144 are disposed between the first and second extension sections 313, 314 of the securing case 3 and the top section 31 of the securing case 3. By means of the rib sections 3134, 3144 of the first and second extension sections 313, 314, when the insulation case 2 or the outer case 5 is connected with the securing case 3, the insulation case 2 and the outer case 5 can lean on the rib sections 3134, 3144 of the first and second extension sections 313, 314 to move toward the securing case 3. Accordingly, when the insulation case 2 or the outer case 5 is connected with the securing case 3, the insulation case 2 or the outer case 5 is prevented from deflecting to cause that the insulation case 2 or the outer case 5 cannot or are hard to connect with the securing case 3. Moreover, the length of the first and second extension sections 313, 314 is larger than the length of the securing case 3. Accordingly, when the insulation case 2 or the outer case 5 is connected with the securing case 3, due to the longer length of the first and second extension sections 313, 314, the insulation case 2 and the outer case 5 can lean on the securing case 3 by longer length so as to enhance the connection stability.

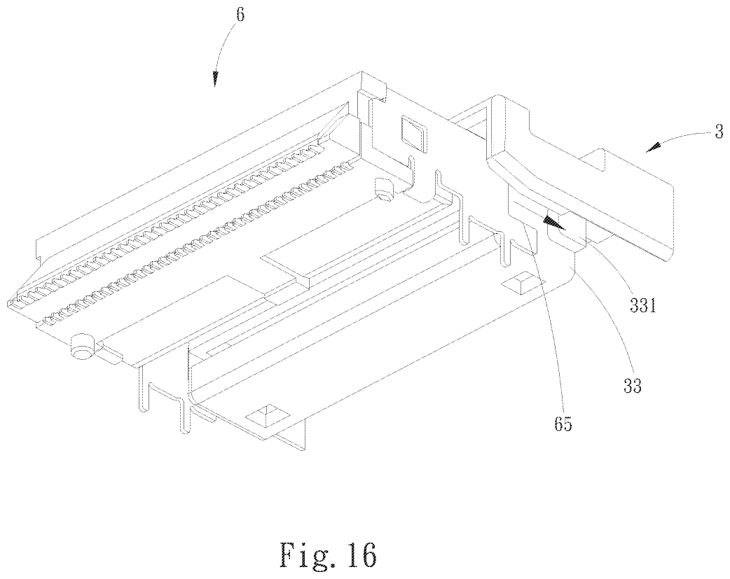

Please further refer to FIG. 15, which is a plane view of another embodiment of the present invention. This embodiment is different from the first embodiment in that at least one guide member 221 is disposed at the rear end 22 of the insulation case 2. The guide members 221 both have a thickness T1 and are side by side arranged in parallel to each other. The guide members 221 define therebetween a first distance W1. Restriction members 3133, 3143 are respectively disposed between the top section 31 of the securing case 3 and the first and second extension sections 313, 314. The first and second extension sections 313, 314 define therebetween a second distance W2. The restriction members 3133, 3143 are perpendicular to the guide members 221. The second distance W2 is equal to the first distance W1 plus the thicknesses T1 of the two guide members 221. Accordingly, when the insulation case 2 is connected with the securing case 3, under the guiding of the guide members 221 of the insulation case 2, the insulation case 2 can enter the securing case 3 between the first and second extension sections 313, 314 to abut against the restriction members 3133, 3143 perpendicular to the guide members 221. Therefore, the guiding and restriction effect of the present invention are further enhanced.

Please refer to FIG. 16, which is a perspective view of still another embodiment of the present invention. This embodiment is different from the first embodiment in that stop sections 331 are respectively disposed on the two lateral sections 33 of the securing case 3. The outer case 6 is formed with at least one recess 65 corresponding to the stop sections 331. In the assembling process of the securing case 3 and the outer case 6, the outer case 6 can be directly pushed into the securing case 3 until the recess 65 is stopped by the stop sections 331 from further entering the securing case 3. Accordingly, the outer case 6 is prevented from over-inserted or under-inserted into the securing case 3 to cause that the upper and lower mating terminals 62, 63 of the outer case 6 are in poor contact with the front end of the circuit board 1. In addition, by means of adjusting the positions of the stop sections 331 and the position of the recess 65, the extent to which the outer case 6 is pushed into the securing case 3 can be adjusted. Accordingly, the depth by which the circuit board 1 is inserted into the outer case 6 can be adjusted.

Please refer to FIGS. 1 and 10, which show still another embodiment of the present invention. The first extension section 313 or the second extension section 314 has a monitoring section 3145. In this embodiment, the monitoring section 3145 is, but not limited to, disposed on the second extension section 314. An operator can observe the connection process of the outer case 6 and the securing case 3 through the monitoring section 3145 so as to quickly check whether the outer case 6 is well connected with the securing case 3.

The present invention has been described with the above embodiments thereof and it is understood that many changes and modifications in such as the form or layout pattern or practicing step of the above embodiments can be carried out without departing from the scope and the spirit of the invention that is intended to be limited only by the appended claims.

What is claimed is:

1. A connector guide device comprising:
an insulation case, a circuit board being disposed in the insulation case, multiple wire bodies being connected and disposed on the circuit board, an upper raised block and at least one lower raised block being disposed at a front end of the insulation case;
a securing case disposed at the front end of the insulation case, a front side of the circuit board outward protruding from the securing case, the securing case having a top section and a bottom section, a fastening member receiving cavity, at least one fastening member retaining section and an upper raised block retaining socket being disposed on the top section, at least one lower raised block retaining socket being disposed on the bottom section, the upper raised block and the lower raised block of the insulation case being respectively plugged into the upper raised block retaining socket and the lower raised block retaining socket to assemble the insulation case and the securing case with each other to form a connector; and
a fastening member disposed in the fastening member receiving cavity of the securing case, the fastening member having a press section, a slope and a plane plate, one side of the plane plate being connected with the slope, a base plate windingly extending from the other side of the slope, the base plate being formed with at least one perforation corresponding to the fastening member retaining section of the securing case, one side of the press section being connected with the slope, while the other side of the press section being positioned above the top section of the securing case, at least one raised body being disposed on a surface of the plane plate for connecting with an outer case, whereby by means of downward pressing the press section, the fastening member can be separated from the outer case to make the connector detach from the outer case.

2. The connector guide device as claimed in claim 1, wherein the outer case has at least one retaining hole for retaining the raised body of the fastening member, whereby the raised body of the fastening member is inlaid and connected in the retaining hole of the outer case.

3. The connector guide device as claimed in claim 1, wherein two stop sections are respectively disposed on two lateral sections of the securing case.

4. The connector guide device as claimed in claim 3, wherein the outer case is formed with at least one recess corresponding to the stop sections of the securing case.

5. The connector guide device as claimed in claim 1, wherein at least one guide member is disposed at the rear end of the insulation case.

6. The connector guide device as claimed in claim 5, wherein at least one restriction member is disposed on the top section of the securing case, the restriction member being perpendicular to the guide member.

7. The connector guide device as claimed in claim 1, wherein the securing case further has a first extension section and a second extension section, multiple rib sections being disposed between the first extension section and the securing case or between the second extension section and the securing case.

8. The connector guide device as claimed in claim 7, wherein the first and second extension sections have a length larger than a length of the securing case.

9. The connector guide device as claimed in claim 7, wherein a monitoring section is disposed on the first extension section or the second extension section.

10. The connector guide device as claimed in claim 1, wherein the securing case has an internal space, a rail being disposed in the internal space, the rail extending through the securing case to form an elongated slot, the circuit board passing through the elongated slot.
